(19) United States
(12) Patent Application Publication
(10) Pub. No.: US 2023/0012316 A1
(43) Pub. Date: Jan. 12, 2023

(54) AUTOMATION OF LEAVE REQUEST PROCESS

(71) Applicant: SAP SE, Walldorf (DE)

(72) Inventors: Prasanna Bhat Mavinakuli, Sagar Tz. (IN); Komal Narsinghani, Bangalore (IN); Subhadeep Khan, Bangalore (IN); Vipul Prabhu, Honnavar (IN)

(21) Appl. No.: 17/370,869

(22) Filed: Jul. 8, 2021

(51) Int. Cl. G06Q 10/10; G06F 40/295; G06N 3/08; G06N 20/20

(52) U.S. Cl. CPC G06Q 10/1093; G06F 40/295; G06N 3/08; G06N 20/20

(57) ABSTRACT

An employee of a large organization sends a human-readable document such as an email or text message to another employee of the organization to inform the other employee of a change in availability. A trained machine-learning model extracts, from the human-readable document, data used by a leave management system (LMS) to formalize and memorialize the leave request. For example, the employee name, manager name, date leave begins, date leave ends, reason for the leave request, or any suitable combination thereof may be determined by the machine-learning model based on the human-readable document. The extracted data is provided to the LMS and the leave request is created.

### TECHNICAL FIELD

The subject matter disclosed herein generally relates to leave requests. Specifically, the present disclosure addresses systems and methods to automatically identify leave requests from other communications.

### BACKGROUND

Using current techniques, an employee in a large organization sends email messages or meeting requests to their supervisor to informally request leave and formally applies for leave in a leave management system. In the case of unplanned leave such as sick leave, the formal process may not be completed before the leave is taken.

### BRIEF DESCRIPTION OF THE DRAWINGS

Some embodiments are illustrated by way of example and not limitation in the figures of the accompanying drawings.

FIG. 1 is a network diagram illustrating an example network environment suitable for automating a leave request process.

FIG. 2 is a block diagram of an example machine learning server, suitable for training a model to automate a leave request process.

FIG. 3 is a block diagram of an example neural network, suitable for use in extracting leave request data from human-readable documents.

FIG. 4 is a block diagram of a pair of example neural networks, suitable for training the neural networks to use similar vector representations for words of different languages with similar meanings.

FIG. 5 is a block diagram of an example database schema, suitable for use in an automated leave request process.

FIG. 6 is a flowchart illustrating operations of an example method suitable for automatically submitting a leave request based on a human-readable document.

FIG. 7 is a flowchart illustrating operations of an example method suitable for training candidate machine-learning models and selecting a trained machine-learning model to use to evaluate human-readable documents.

FIG. 8 is a block diagram illustrating an example user interface, suitable for use in an automated leave request process.

FIG. 9 is a block diagram showing one example of a software architecture for a computing device.

FIG. 10 is a block diagram of a machine in the example form of a computer system within which instructions may be executed for causing the machine to perform any one or more of the methodologies discussed herein.

### DETAILED DESCRIPTION

Example methods and systems are directed to automatically processing human-readable leave requests. An employee of a large organization sends a human-readable document such as an email or text message to another employee of the organization (e.g., a manager or a peer) to inform the other employee of a change in availability.

A leave request is a request for time off of work. A human-readable document is a document intended to be read by a human (e.g., a text file, a text message, an email, a word processor file, and the like) and is distinguished from a machine-readable document intended to be read by a machine (e.g., a bar code, a JavaScript object notation (JSON) file, a binary database file, and the like). Typically, a human-readable document does not have a formally defined structure while a machine-readable document does. For example, a machine-readable document may include a fixed number of fields, using a specific encoding, and present in a prescribed order.

A trained machine-learning model extracts, from the human-readable document, data used by a leave management system (LMS) to formalize and memorialize the leave request. For example, the employee name, manager name, date leave begins, date leave ends, reason for the leave request, or any suitable combination thereof may be determined by the machine-learning model based on the human-readable document.

The extracted data is provided to the LMS and the leave request is created. As a result, the employee need not manually reorganize the data into a form expected by the LMS and submit it.

The machine-learning model may be trained using a set of annotated human-readable documents. For example, a set of stored leave request communications may be annotated by hand and used as a training set. The machine-learning model is trained on the training set to generate labels for the annotated communications that match the annotations.

After training, a test set of annotated communications that does not include any communications in the training set, is used to evaluate the accuracy of the trained machine-learning model. Multiple models may be trained and evaluated. Based on the evaluation of the models, a single model having the best accuracy is selected for deployment.

Once deployed, the machine-learning model is enabled to access leave request communications and generate data for the LMS without requiring a user to enter the leave request data into a form. By contrast with implementations that use a separate LMS form, the employee only provides the leave request information once, in a human-readable document and not twice, in the human-readable document and in a machine-readable communication requested by the LMS.

When these effects are considered in aggregate, one or more of the methodologies described herein may obviate a need for certain efforts or resources that otherwise would be involved in requesting leave. Computing resources used by one or more machines, databases, or networks may similarly be reduced. Examples of such computing resources include processor cycles, network traffic, memory usage, data storage capacity, power consumption, and cooling capacity.

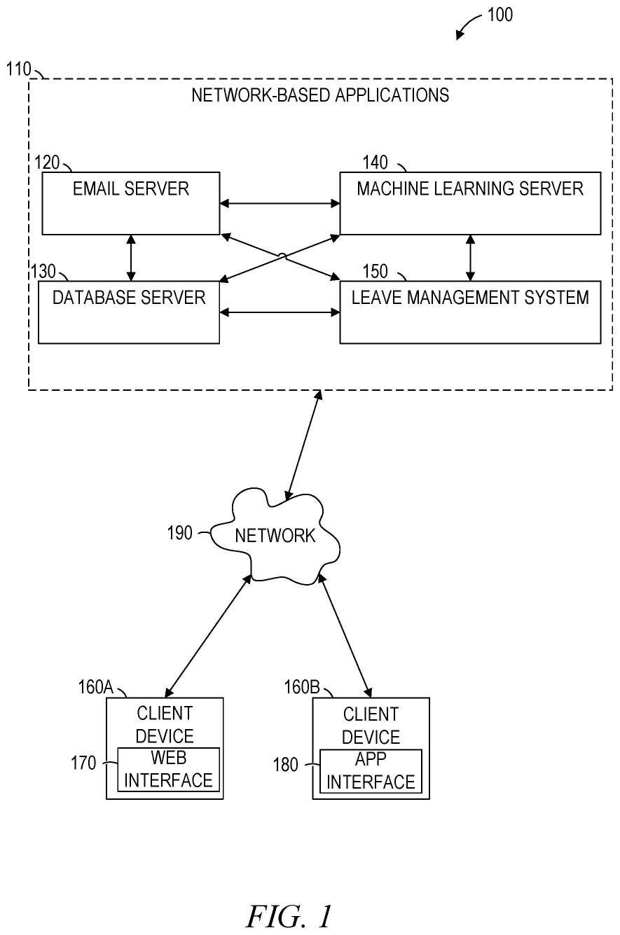

FIG. 1 is a network diagram illustrating an example network environment 100 suitable for automating a leave request process. The network environment 100 includes network-based applications 110, client devices 160A and 160B, and a network 190. The network-based applications 110 are provided by email server 120 and leave management system 150 in communication with database server 130 and machine learning server 140.

The client devices 160A and 160B send and receive email by communication with the email server 120 via the network 190. The email server 120 stores and accesses email data in the database server 130.

The machine learning server 140 accesses training data from the database server 130, trains one or more machine learning models, tests one or more of the machine learning models using test data accessed from the database server 130, and selects a trained machine learning model. The trained machine learning model processes human-readable documents to generate leave requests for the leave management system 150.

The leave management system 150 receives leave requests from the client devices 160A-160B, from the machine learning server 140, or both. The leave management system 150 stores and accesses leave data in the database server 130.

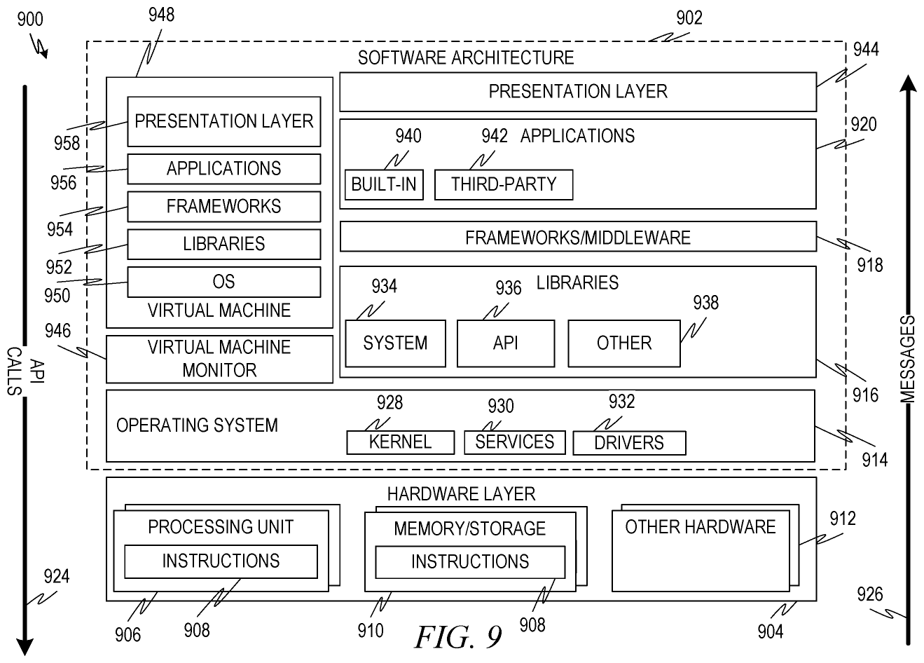

The email server 120, the machine learning server 140, the leave management system 150, or any suitable combination thereof provide applications to the client devices 160A and 160B via a web interface 170 or an application interface 180. The email server 120, the database server 130, the machine learning server 140, the leave management system 150, and the client devices 160A and 160B may each be implemented in a computer system, in whole or in part, as described below with respect to FIG. 9. The client devices 160A and 160B may be referred to collectively as client devices 160 or generically as a client device 160.

Though two client devices 160 are shown, more client devices 160 are contemplated. For example, thousands or millions of users may each have their own client device 160. Similarly, while a single database server 130 is shown, more or fewer database servers are contemplated. For example, a separate database server 130 may store data for each of the email server 120, the machine learning server 140, and the leave management system 150. As another example, the email server 120, the machine learning server 140, and the leave management system 150 may each store data locally instead of by accessing the database server 130. Additionally or alternatively, the database server 130 may be replaced by a distributed database comprising a cluster of multiple nodes.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The email server 120, the database server 130, the machine learning server 140, the leave management system 150, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

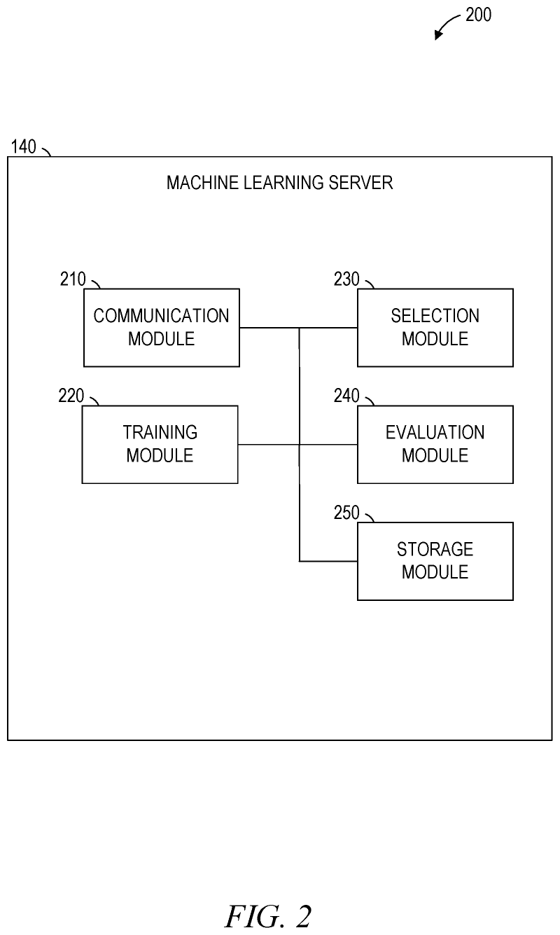

FIG. 2 is a block diagram 200 of an example machine learning server 140, suitable for training a model to automate a leave request process. The machine learning server 140 is shown as including a communication module 210, a training module 220, a selection module 230, an evaluation module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the machine learning server 140 and transmits data from the machine learning server 140. For example, the communication module 210 may receive, from the email server 120, a human-readable document that contains leave request data. The communication module 210 provides the human-readable document to the evaluation module 240, which extracts the leave request data and provides the extracted data, via the communication module 210, to the leave management system 150. Communications sent and received by the communication module 210 may be intermediated by the network 190.

The selection module 230 selects a trained model to use from a plurality of machine learning models trained by the training module 220. Selection of the model to use may include generating a score for each trained model and selecting the model with the highest score. For example, an annotated testing set may be provided to each of the plurality of trained machine learning models and the results generated by each model compared with the annotations to generate an accuracy score. The model with the highest accuracy score may be selected as the model to use. The selected model is stored using the storage module 250; the remaining models may be discarded.

Once a trained model is selected, the evaluation module 240 uses the selected model to identify leave request data from human-readable documents. The identified data is provided to the leave management system 150, thus streamlining the leave request process. For example, a manager may receive an email from a subordinate, requesting leave for a particular range of dates. Rather than manually entering (or having the subordinate or a secretary enter) the data into a form provided by the leave management system 150, the email is forwarded to the machine learning server 140 for evaluation by the evaluation module 240.

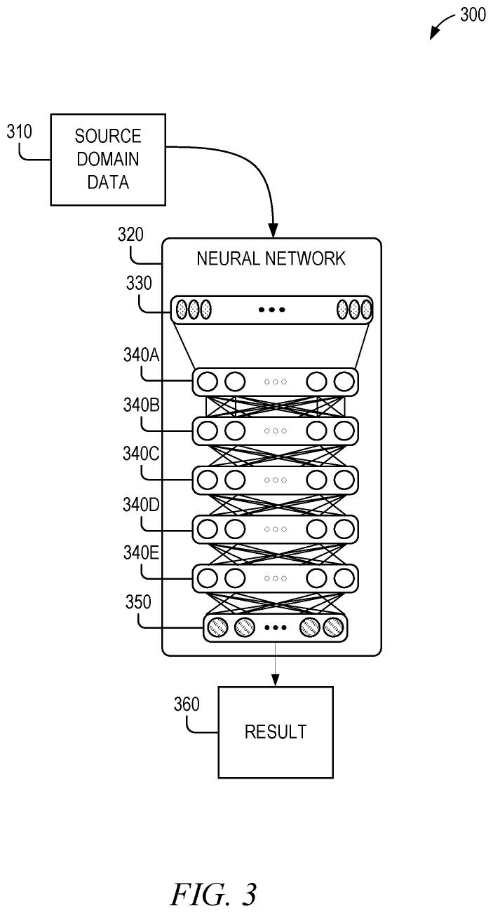

FIG. 3 is a block diagram of an example neural network 320, suitable for use in extracting leave request data from human-readable documents. The neural network 320 takes source domain data 310 as input, processes the source domain data 310 using the input layer 330; the intermediate, hidden layers 340A, 340B, 340C, 340D, and 340E; and the output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. As another example, in natural language processing, a neural network may be taught to recognize semantic meaning in human-readable text by analyzing example documents that have been tagged with meanings and, having learnt the correlation between source text and tagged meanings, may use the analytic results to identify meaning in untagged text.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 340 is the result 360. The intermediate layers 340A-340E are referred to as “hidden” because they do not interact directly with either the input or the output, and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. The number of epochs may be 10, 100, 500, 1000, or another number. Within an epoch, one or more batches of the training dataset are used to train the model. Thus, the batch size ranges between 1 and the size of the training dataset while the number of epochs is any positive integer value. The model parameters are updated after each batch (e.g., using gradient descent).

In a supervised learning phase, a model is developed to predict the output for a given set of inputs, and is evaluated over several epochs to more reliably provide the output that is specified as corresponding to the given input for the greatest number of inputs for the training dataset. The training dataset comprises input examples with labeled outputs. For example, a user may label images based on their content and the labeled images used to train an image identifying model to generate the same labels.

For self-supervised learning, the training dataset comprises self-labeled input examples. For example, a set of color images could be automatically converted to black-and-white images. Each color image may be used as a “label” for the corresponding black-and-white image, and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. The finalized models may be evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning. A neuron implements a transfer function by which a number of inputs are used to generate an output. The inputs may be weighted and summed, with the result compared to a threshold to determine if the neuron should generate an output signal (e.g., a 1) or not (e.g., a 0 output). Through the training of a neural network, the inputs of the component neurons are modified. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

The structure of each layer may be predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, deep neural networks, genetic or evolutionary algorithms, and the like.

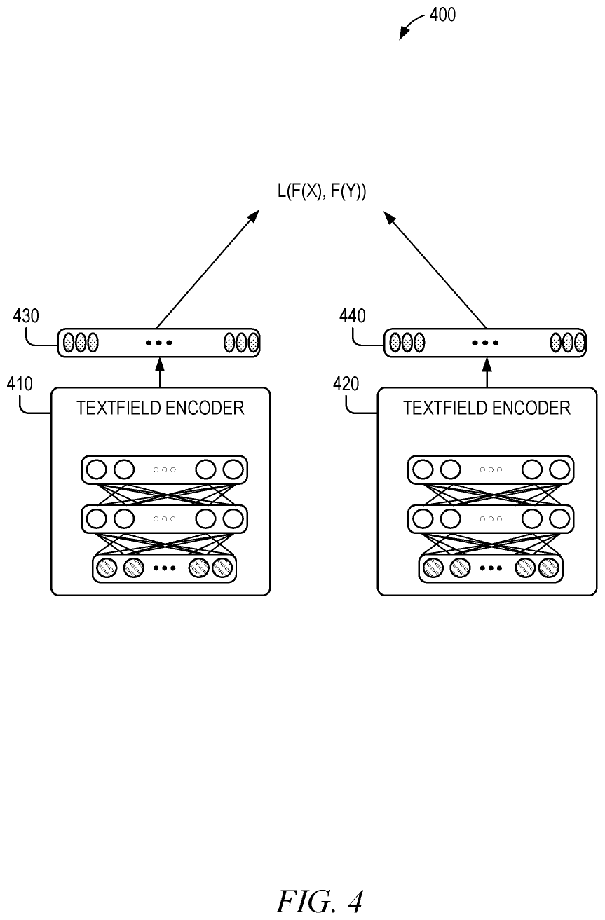

FIG. 4 is a block diagram of an example model architecture 400 for aligning multilingual embeddings. The model architecture 400 includes language embedders 410 and 420 and resulting vectors 430 and 440. The language embedders 410 and 420 are trained so that the distance (or loss) function for two related text strings is reduced or minimized. For example, the same natural language text may be provided in two languages for training and the two resulting embeddings aligned using the model architecture 400.

The specific architecture of the language embedders 410 and 420 may be chosen dependent on the type of input data for an embedding layer that is followed by some encoder architecture that creates a vector from the sequence. Embeddings and encoder parameters are shared between the text fields. In the simplest case the encoder stage is just elementwise average of the token embeddings.

Alternatively, the encoding may include converting pairs of words of the text to bigram vectors and combining the bigram vectors to generate a vector for the text. For example, the text “employee name” may have a corresponding vector as a bigram, rather than two separate vectors for “employee” and “name” that are combined. The text “I will be on vacation from May 6^{th 6}to May 12^{th}” may be stripped of articles and prepositions and converted to vectors for each of the bigrams “I will,” “will be,” “be vacation,” “vacation May,” “May 6^{th},” “6^{th} May”, and “May 12^{th}.” The vector for a text string may be determined as an average of the bigram vectors for the bigrams in the text string.

Each of the language embedders 410 and 420 receives feedback based on the loss function L for outputs of the language embedders 410 and 420 generated from pairs of inputs X and Y. X is an input (e.g., a word, bigram, or phrase) in the first language. Y is an input in the second language having a corresponding meaning to X in the first language. F(X) is the output of the first language embedder 410 when X is the input. G(Y) is the output of the second language embedder 420 when Y is the input. Thus, when the language embedders 410 and 420 are trained to minimize the loss function L, the output vectors F(X) and G(Y) increase in similarity.

More than two language embedders may be simultaneously aligned, using a loss function that takes more than two parameters. Alternatively, iterative pairwise trainings may be performed until the average loss for every pair is below a threshold. As another alternative, one language embedder (e.g., the first language embedder 410) may be left unchanged during the training process, forcing all of the changes to achieve alignment to be made by the other language embedder (e.g., the second language embedder 420). The unchanging language embedder may be paired with each other language embedder without iteration.

Using the model architecture 400, one or more machine learning models may be trained for multilingual text processing. Thus, the language or languages an individual model is trained to process is one of the variables that may differ between the multiple models trained by the training module 220 of FIG. 2 and, based on the performance of the resulting models, selected from by the selection module 230.

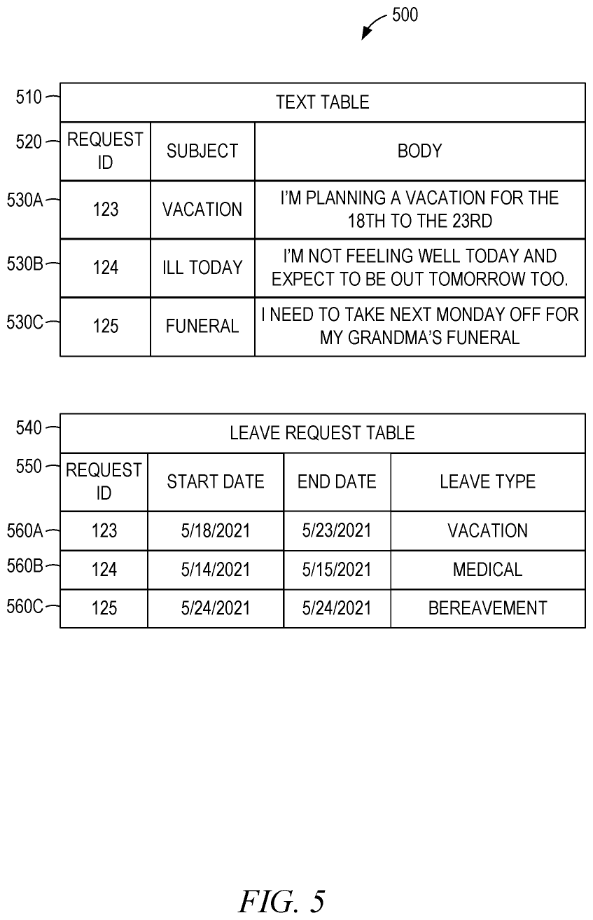

FIG. 5 is a block diagram of an example database schema 500, suitable for use in an automated leave request process. The database schema 500 may be used by the database server 130 of FIG. 1 to store and provide access to data used by the email server 120, the machine learning server 140, the leave management system 150, or any suitable combination thereof. The database schema 500 includes a text table 510 and a leave request table 540. The text table 510 includes rows 530A, 530B, and 530C of a format 520. The leave request table 540 includes rows 560A, 560B, and 560C of a format 550.

The format 520 of the text table 510 includes a request identifier field, a subject field, and a body field. Each of the rows 530A-530C stores data for a single human-readable document. The request identifier field stores a unique identifier for the communication (e.g., a sequential identifier, a timestamp, an identifier based on the user or device that created the communication, or any suitable combination thereof). The subject field stores the subject of the communication (e.g., a subject field of an email, a “regarding” field of a memo, a title of an article, and the like). The body field stores the body of the communication (e.g., the body of an email, text message, memo, or article).

Rows in the text table 510 may be created by the email server 120 or other communication servers. For example, a user of the client device 160A may send an email to a user of the client device 160B. In creating the email, the text of the email is sent from the client device 160A to the email server 120 via the network 190. The email server 120 stores the text of the email in the text table 510 and sends a copy of the email to the client device 160B. The user of the client device 160B may identify the email as containing a leave request and forward the email to an email address assigned to the machine learning server 140. The machine learning server 140 receives the email from the email server 120 or accesses the text from the text table 510 for evaluation by the evaluation module 240 of FIG. 2. The leave request table 540 may be populated by the evaluation module 240 of the machine learning server 140, populated by user interaction with the leave management system 150, or any suitable combination thereof.

Each of the rows 560A-560C of the leave request table 540 stores information for a leave request handled by the leave management system 150. As indicated by the format 550, each leave request includes a request identifier, a start date for the leave, an end date for the leave, and a leave type. Thus, the row 560A is for request for a vacation from May 18 to May 21, 2021. The request identifier of the leave request table 540 may correspond to the request identifier of the text table 510 such that a matching request identifier shows that a row in the leave request table 540 was generated based on the corresponding row in the text table 510. Alternatively, the request identifier of the leave request table 540 may be assigned by the leave management system 150 independent of a request identifier of the text table 510 assigned by the email server 120.

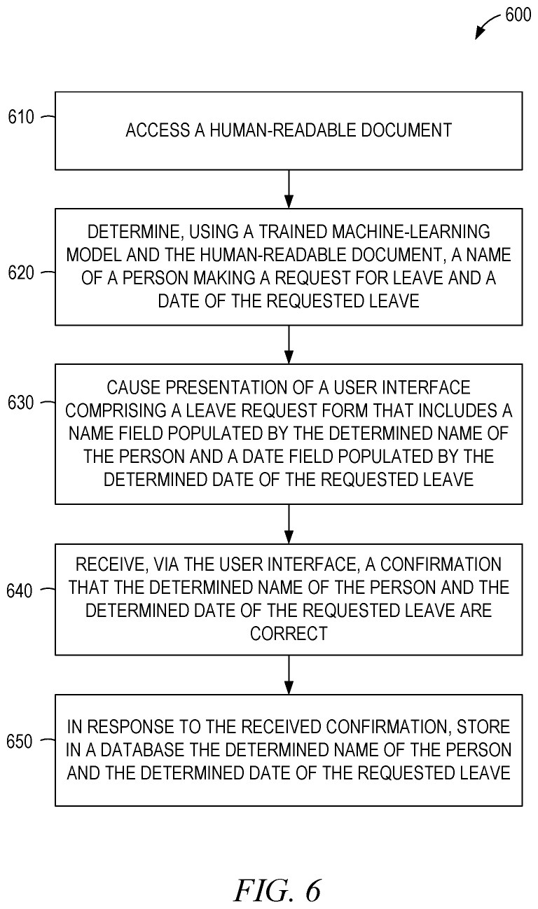

FIG. 6 is a flowchart illustrating operations of an example method 600 suitable for automatically submitting a leave request based on a human-readable document. The method 600 includes operations 610, 620, 630, 640, 650, and 660. By way of example and not limitation, the method 600 is described as being performed by the devices, modules, and databases of FIGS. 1-5.

In operation 610, the evaluation module 240 of FIG. 2 accesses a human-readable document. For example, an email sent by a user of the client device 160A to a user of the client device 160B via the email server 120 may be stored by the database server 130 and accessed by the evaluation module 240 of the machine learning server 140. The human-readable document may be accessed in response to detecting that it was sent (e.g., all emails may be processed by the method 600) or accessed in response to being received by a predefined account (e.g., the user of the client device 160B may forward an email to an email address associated with the machine learning server 140 or forward a text message to a phone number associated with the machine learning server 140, such that the method 600 is performed only for emails sent to the email address or text messages sent to the phone number).

The evaluation module 240, in operation 620, determines, using a trained machine-learning model and the human-readable document, a name of a person making a request for leave and a date of the requested leave. For example, the words of the human-readable document may be converted to a vector representation using a language embedder and the vectors provided as input to a trained machine-learning model. As output, the machine-learning model produces one or more vectors that are converted into the values of fields for a leave request, such as the name of the person making the request for leave, a start date of the requested leave, an end date of the requested leave, a duration of the requested leave, a reason for the requested leave, a name of a person responsible for approving the requested leave (e.g., a supervisor, a manager, or a human resources (HR) director), an email address of the person making the leave request, an email address of the person responsible for approving the leave, or any suitable combination thereof.

To determine the values of the fields for the leave request, an inference post request may be submitted using a representational state transfer (“REST”) application programming interface (“API”). The inference post request is submitted to the BER API either as a text or as a dataset id in case of batch processing. The data is added to the database and an asynchronous request is sent to an orchestrator. The orchestrator then validates the data from the dataset, divide it to chunks, and delegates multiple requests to worker application. The orchestrator then waits for all requests to complete, post which it consolidates results to result file. The predicted results can be extracted from the database in case of single text, or download the result file in case of batch processing.

The values of the fields for the leave request are provided to the leave management system 150 to initiate a leave request process. In operation 630, the leave management system 150 causes a user interface to be presented that comprises a leave request form that includes a name field populated by the determined name of the person and a date field populated by the determined date of the requested leave. The user interface may be displayed on a display of a client device associated with a person or role responsible for approving the leave request. For example, the user interface may be displayed on the client device used by a manager to forward the leave request email, displayed on the mobile device used by the manager to forward the leave request text message, displayed in response to a push notification received on a device associated with a person identified in the human-readable leave request document, or any suitable combination thereof. By populating the form with data values determined based on the human-readable document, human effort in entering the data is saved. Further, the time (and thus, processor clock cycles and energy consumption) for completing the time is reduced.

In operation 640, the leave management system 150 receives, via the user interface, a confirmation that the determined name of the person and the determined date of the requested leave are correct. Alternatively, the leave management system 150 may receive, via the user interface, modifications of one or more of the populated fields, additional data in unpopulated fields, or any suitable combination thereof.

The leave management system 150, in operation 650, in response to the received confirmation, stores the determined name of the person and the determined date of the requested leave in a database. For example, a record may be added to the leave request table 540 of FIG. 5. Thus, by use of the method 600, a leave request is made and both a computer-readable database is updated and a human-readable document is sent without requiring a user to both send a human-readable document to a manager or peers and to initiate and complete a computer-readable form.

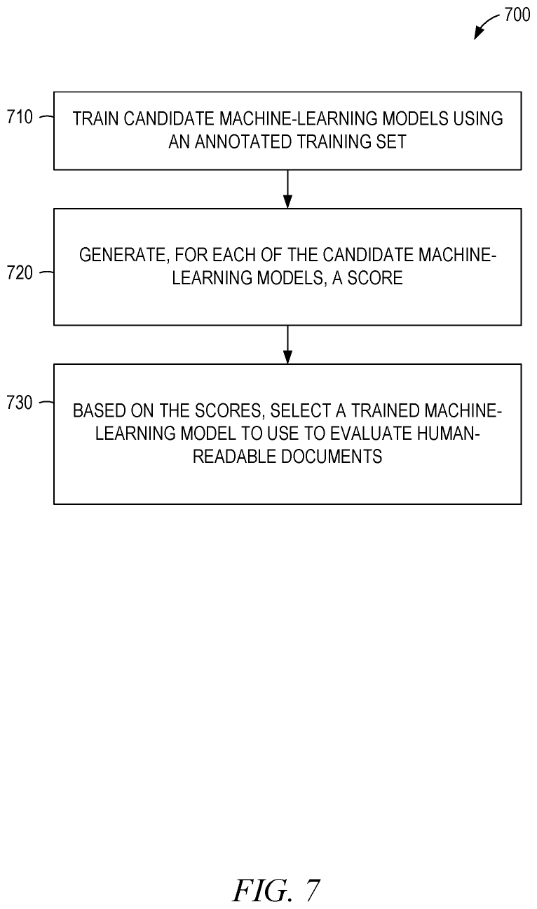

FIG. 7 is a flowchart illustrating operations of an example method 700 suitable for training candidate machine-learning models and selecting a trained machine-learning model to use to evaluate human-readable documents. The method 700 comprises operations 710, 720, and 730. By way of example and not limitation, the method 700 is described as being performed by the devices, modules, and databases of FIGS. 1-5.

In operation 710, the training module 220 of the machine learning server 140 (FIGS. 1-2) trains a plurality of candidate machine-learning models using an annotated training set. For example, hundreds or thousands of human-readable documents may be annotated to indicate which part of each human-readable document indicates specific data used for leave requests (e.g., name of requester, date of leave start, date of leave end, leave duration, name of supervisor, reason for leave, or any suitable combination thereof). Prior to being used in the training set, each annotated document may be validated for schema and the indices of labels in the text. The annotated training set is used to train different machine-learning models, which may have the general structure of the neural network 320 of FIG. 3.

The different machine-learning models may have different parameters, such as different numbers of hidden layers, different random initialization states, different pre- or post-processing steps for input or output data, or any suitable combination thereof. As another example of differences between the candidate machine-learning models, a first candidate model of the plurality of candidate machine-learning models may use a first natural language embedding based on a single first natural language, a second candidate model of the plurality of candidate machine-learning models may use a second natural language embedding based on a single second natural language, and a third candidate model of the plurality of candidate machine-learning models may use a third natural language embedding based on the first natural language and the second natural language (e.g., using the model architecture 400 of FIG. 4 for aligning multilingual embeddings). The machine-learning models may be convolutional neural networks (CNNs), recurrent neural networks (RNNs), or any suitable combination thereof. Additionally or alternatively, one or more of the candidate machine-learning models may use a denoising autoencoder while a different one or more of the candidate machine-learning models does not. A denoising autoencoder randomly turns some input values to zero during training, preventing the machine-learning model from exactly learning the training set without determining generalized heuristics applicable to other documents.

The selection module 230, in operation 720, generates, for each of the plurality of candidate machine-learning models, a score. For example, a separate set of hundreds or thousands of human-readable documents may be annotated to form an annotated testing set. The annotated testing set may have some records in common with the annotated training set or may have no records in common. The annotated documents of the testing set are used to determine an accuracy of each candidate machine-learning model (e.g., a number of fields correctly identified, a number of human-readable documents from which all data was extracted without error, or a suitable combination thereof).

Based on the scores, the selection module 230 selects a trained machine-learning model to use to evaluate human-readable documents (operation 730). For example, the candidate machine-learning model with the highest accuracy may be selected and used by the evaluation module 240 to perform operations 610 and 620 of the method 600.

By use of the method 700 and by comparison with alternative methods that use a single machine-learning model, a machine-learning model with greater accuracy is used. As a result, fewer manual corrections of data generated by the machine-learning model are performed, reducing effort in a leave management process and saving related computing resources such as processor cycles, power consumption, network bandwidth, and the like.

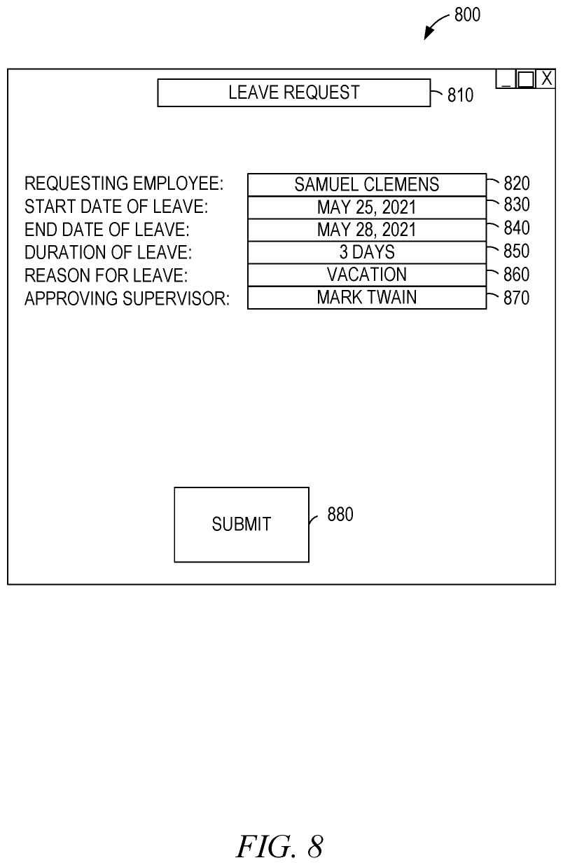

FIG. 8 is a block diagram illustrating an example user interface 800, suitable for use in an automated leave request process. The user interface 800 includes a title 810, data fields 820, 830, 840, 850, 860, and 870, and a button 880. The user interface 800 may be displayed on the client devices 160A or 160B of FIG. 1 in response to instructions received from the leave management system 150, in operation 630 of the method 600 of FIG. 6. For example, an HTML file may be transmitted from the leave management system to the client device 160A via the network 190 for display using the web interface 170.

The title 810 indicates that the user interface 800 is for handling a leave request. The data fields 820-870 are initially populated with values determined by a trained machine-learning model based on a human-readable document. By interacting with the data fields 820-870, a user may change the initially populated values, add values that were not initially populated, or both. For example, the start date of leave could be changed to a different date, a typographical error that appeared in the human-readable document could be corrected, or any other modification could be made.

In response to detecting an interaction with the button 880, the data in any updated data fields is provided to the leave management system 150. The leave management system 150 stores the leave request data in a database (e.g., in the leave request table 540 of FIG. 5), completing the leave request process.

By use of the user interface 800 including data populated by a machine-learning model, time and effort involved in making leave requests is reduced. As a result, fewer keystrokes, gestures, or mouse clicks are received by the client device 160A or 160B in receiving the data entry, reducing the use of computing resources (e.g., processor cycles, power consumption, and memory accesses) in providing a leave request user interface.

In view of the above described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors, a human-readable document; determining, by the one or more processors, using a trained machine-learning model and the human-readable document, a name of a person making a request for leave and a date of the requested leave; causing presentation of a user interface comprising a leave request form that includes, a name field that is populated by the determined name of the person and a date field that is populated by the determined date of the requested leave; receiving, via the user interface, a confirmation that the determined name of the person and the determined date of the requested leave are correct; and in response to the received confirmation, storing in a database the determined name of the person and the determined date of the requested leave.

In Example 2, the subject matter of Example 1 includes, training a plurality of candidate machine-learning models using an annotated training set; generating, for each candidate machine-learning model of the plurality of candidate machine-learning models, a score; based on the scores, selecting the trained machine-learning model from the plurality of candidate machine-learning models.

In Example 3, the subject matter of Example 2 includes, wherein: the annotated training set comprise a first plurality of annotated records; and the generating of the scores for the plurality of candidate machine-learning models comprises using an annotated testing set that comprises a second plurality of annotated records, the first plurality of annotated records and the second plurality of annotated records not having any records in common.

In Example 4, the subject matter of Example 3 includes, wherein: a first candidate model of the plurality of candidate machine-learning models uses a first natural language embedding based on a single first natural language; a second candidate model of the plurality of candidate machine-learning models uses a second natural language embedding based on a single second natural language; and a third candidate model of the plurality of candidate machine-learning models uses a third natural language embedding based on the first natural language and the second natural language.

In Example 5, the subject matter of Example 4 includes, wherein: a first candidate model of the plurality of candidate machine-learning models uses a denoising autoencoder; and a second candidate model of the plurality of candidate machine-learning models does not use any denoising autoencoder.

In Example 6, the subject matter of Examples 1-5 includes, determining, using the trained machine-learning model and the human-readable document, a name of a supervisor of the person making the request for leave.

In Example 7, the subject matter of Examples 1-6 includes, determining, using the trained machine-learning model and the human-readable document, a duration of the requested leave.

In Example 8, the subject matter of Examples 1-7 includes, wherein: the accessing of the human-readable document comprises accessing an email sent by the person making the request for leave, the request for leave comprising a request for time off of work.

In Example 9, the subject matter of Examples 1-8 includes, wherein: the accessing of the human-readable document comprises accessing a text message.

Example 10 is a system comprising: a memory that stores instructions; and one or more processors configured by the instructions to perform operations comprising: accessing a human-readable document; determining, using a trained machine-learning model and the human-readable document, a name of a person making a request for leave and a date of the requested leave; causing presentation of a user interface comprising a leave request form that includes, a name field that is populated by the determined name of the person and a date field that is populated by the determined date of the requested leave; receiving, via the user interface, a confirmation that the determined name of the person and the determined date of the requested leave are correct; and in response to the received confirmation, storing in a database the determined name of the person and the determined date of the requested leave.

In Example 11, the subject matter of Example 10 includes, wherein the operations further comprise: training a plurality of candidate machine-learning models using an annotated training set; generating, for each candidate machine-learning model of the plurality of candidate machine-learning models, a score; based on the scores, selecting the trained machine-learning model from the plurality of candidate machine-learning models.

In Example 12, the subject matter of Example 11 includes, wherein: the annotated training set comprise a first plurality of annotated records; and the generating of the scores for the plurality of candidate machine-learning models comprises using an annotated testing set that comprises a second plurality of annotated records, the first plurality of annotated records and the second plurality of annotated records not having any records in common.

In Example 13, the subject matter of Example 12 includes, wherein: a first candidate model of the plurality of candidate machine-learning models uses a first natural language embedding based on a single first natural language; a second candidate model of the plurality of candidate machine-learning models uses a second natural language embedding based on a single second natural language; and a third candidate model of the plurality of candidate machine-learning models uses a third natural language embedding based on the first natural language and the second natural language.

In Example 14, the subject matter of Example 13 includes, wherein: a first candidate model of the plurality of candidate machine-learning models uses a denoising autoencoder; and a second candidate model of the plurality of candidate machine-learning models does not use any denoising autoencoder.

In Example 15, the subject matter of Examples 10-14 includes, wherein the operations further comprise: determining, using the trained machine-learning model and the human-readable document, a name of a supervisor of the person making the request for leave.

In Example 16, the subject matter of Examples 10-15 includes, wherein the operations further comprise: determining, using the trained machine-learning model and the human-readable document, a duration of the requested leave.

In Example 17, the subject matter of Examples 10-16 includes, wherein the operations further comprise: the accessing of the human-readable document comprises accessing an email sent by the person making the request for leave, the request for leave comprising a request for time off of work.

Example 18 is a non-transitory computer-readable medium that stores instructions that, when executed by one or more processors, cause the one or more processors to perform operations comprising: accessing a human-readable document; determining, using a trained machine-learning model and the human-readable document, a name of a person making a request for leave and a date of the requested leave; causing presentation of a user interface comprising a leave request form that includes, a name field that is populated by the determined name of the person and a date field that is populated by the determined date of the requested leave; receiving, via the user interface, a confirmation that the determined name of the person and the determined date of the requested leave are correct; and in response to the received confirmation, storing in a database the determined name of the person and the determined date of the requested leave.

In Example 19, the subject matter of Example 18 includes, wherein the operations further comprise: training a plurality of candidate machine-learning models using an annotated training set; generating, for each candidate machine-learning model of the plurality of candidate machine-learning models, a score; based on the scores, selecting the trained machine-learning model from the plurality of candidate machine-learning models.

In Example 20, the subject matter of Example 19 includes, wherein: the annotated training set comprise a first plurality of annotated records; and the generating of the scores for the plurality of candidate machine-learning models comprises using an annotated testing set that comprises a second plurality of annotated records, the first plurality of annotated records and the second plurality of annotated records not having any records in common.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

FIG. 9 is a block diagram 900 showing one example of a software architecture 902 for a computing device. The architecture 902 may be used in conjunction with various hardware architectures, for example, as described herein. FIG. 9 is merely a non-limiting example of a software architecture and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 may provide a higher-level common infrastructure that may be utilized by the applications 920 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), frameworks/middleware 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

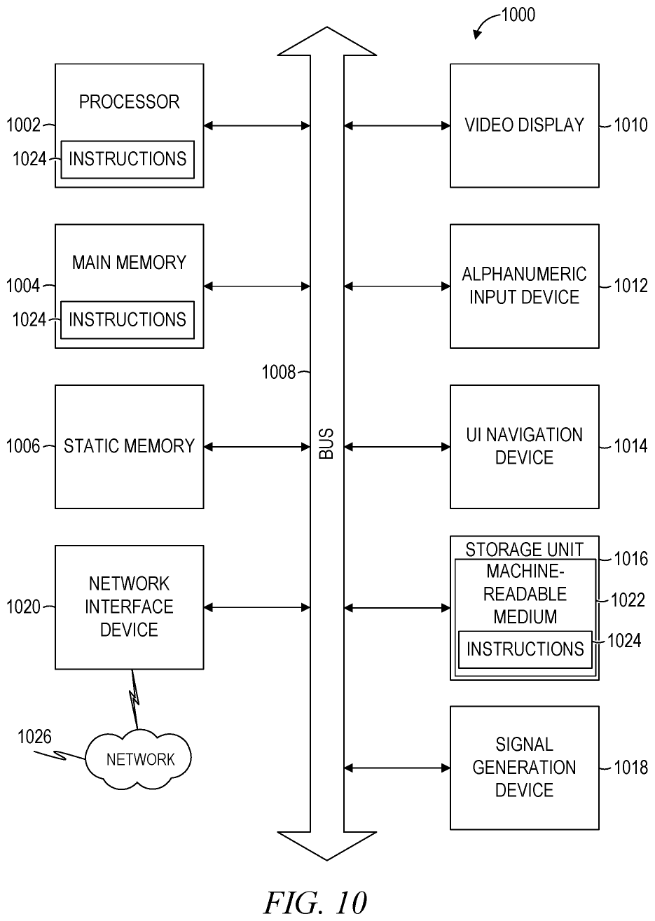

FIG. 10 is a block diagram of a machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media 1022.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM)disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors, a human-readable document;
determining, by the one or more processors, using a trained machine-learning model and the human-readable document, a name of a person making a request for leave and a date of the requested leave;
causing presentation of a user interface comprising a leave request form that includes a name field that is populated by the determined name of the person and a date field that is populated by the determined date of the requested leave;
receiving, via the user interface, a confirmation that the determined name of the person and the determined date of the requested leave are correct; and
in response to the received confirmation, storing in a database the determined name of the person and the determined date of the requested leave.

2. The method of claim 1, further comprising:
training a plurality of candidate machine-learning models using an annotated training set;
generating, for each candidate machine-learning model of the plurality of candidate machine-learning models, a score; and
based on the scores, selecting the trained machine-learning model from the plurality of candidate machine-learning models.

3. The method of claim 2, wherein:
the annotated training set comprise a first plurality of annotated records; and
the generating of the scores for the plurality of candidate machine-learning models comprises using an annotated testing set that comprises a second plurality of annotated records, the first plurality of annotated records and the second plurality of annotated records not having any records in common.

4. The method of claim 3, wherein:
a first candidate model of the plurality of candidate machine-learning models uses a first natural language embedding based on a single first natural language;
a second candidate model of the plurality of candidate machine-learning models uses a second natural language embedding based on a single second natural language; and
a third candidate model of the plurality of candidate machine-learning models uses a third natural language embedding based on the first natural language and the second natural language.

5. The method of claim 4, wherein:
a first candidate model of the plurality of candidate machine-learning models uses a denoising autoencoder; and
a second candidate model of the plurality of candidate machine-learning models does not use any denoising autoencoder.

6. The method of claim 1, further comprising:
determining, using the trained machine-learning model and the human-readable document, a name of a supervisor of the person making the request for leave.

7. The method of claim 1, further comprising:
determining, using the trained machine-learning model and the human-readable document, a duration of the requested leave.

8. The method of claim 1, wherein:
the accessing of the human-readable document comprises accessing an email sent by the person making the request for leave, the request for leave comprising a request for time off of work.

9. The method of claim 1, wherein:
the accessing of the human-readable document comprises accessing a text message.

10. A system comprising:
a memory that stores instructions; and
one or more processors configured by the instructions to perform operations comprising:
accessing a human-readable document;
determining, using a trained machine-learning model and the human-readable document, a name of a person making a request for leave and a date of the requested leave;
causing presentation of a user interface comprising a leave request form that includes a name field that is populated by the determined name of the person and a date field that is populated by the determined date of the requested leave;
receiving, via the user interface, a confirmation that the determined name of the person and the determined date of the requested leave are correct; and
in response to the received confirmation, storing in a database the determined name of the person and the determined date of the requested leave.

11. The system of claim 10, wherein the operations further comprise:
training a plurality of candidate machine-learning models using an annotated training set;
generating, for each candidate machine-learning model of the plurality of candidate machine-learning models, a score; and
based on the scores, selecting the trained machine-learning model from the plurality of candidate machine-learning models.

12. The system of claim 11, wherein:
the annotated training set comprise a first plurality of annotated records; and
the generating of the scores for the plurality of candidate machine-learning models comprises using an annotated testing set that comprises a second plurality of annotated records, the first plurality of annotated records and the second plurality of annotated records not having any records in common.

13. The system of claim 12, wherein:
a first candidate model of the plurality of candidate machine-learning models uses a first natural language embedding based on a single first natural language;
a second candidate model of the plurality of candidate machine-learning models uses a second natural language embedding based on a single second natural language; and
a third candidate model of the plurality of candidate machine-learning models uses a third natural language embedding based on the first natural language and the second natural language.

14. The system of claim 13, wherein:
a first candidate model of the plurality of candidate machine-learning models uses a denoising autoencoder; and
a second candidate model of the plurality of candidate machine-learning models does not use any denoising autoencoder.

15. The system of claim 10, wherein the operations further comprise:
determining, using the trained machine-learning model and the human-readable document, a name of a supervisor of the person making the request for leave.

16. The system of claim 10, wherein the operations further comprise:
determining, using the trained machine-learning model and the human-readable document, a duration of the requested leave.

17. The system of claim 10, wherein the operations further comprise:
the accessing of the human-readable document comprises accessing an email sent by the person making the request for leave, the request for leave comprising a request for time off of work.

18. A non-transitory computer-readable medium that stores instructions that, when executed by one or more processors, cause the one or more processors to perform operations comprising:
accessing a human-readable document;
determining, using a trained machine-learning model and the human-readable document, a name of a person making a request for leave and a date of the requested leave;
causing presentation of a user interface comprising a leave request form that includes a name field that is populated by the determined name of the person and a date field that is populated by the determined date of the requested leave;
receiving, via the user interface, a confirmation that the determined name of the person and the determined date of the requested leave are correct; and
in response to the received confirmation, storing in a database the determined name of the person and the determined date of the requested leave.

19. The computer-readable medium of claim 18, wherein the operations further comprise:
training a plurality of candidate machine-learning models using an annotated training set;
generating, for each candidate machine-learning model of the plurality of candidate machine-learning models, a score; and
based on the scores, selecting the trained machine-learning model from the plurality of candidate machine-learning models.

20. The computer-readable medium of claim 19, wherein:
the annotated training set comprise a first plurality of annotated records; and
the generating of the scores for the plurality of candidate machine-learning models comprises using an annotated testing set that comprises a second plurality of annotated records, the first plurality of annotated records and the second plurality of annotated records not having any records in common.
